(19) United States
(12) Patent Application Publication
(10) Pub. No.: US 2007/0283569 A1
(43) Pub. Date: Dec. 13, 2007

(54) Egg cracker apparatus and method

(76) Inventor: Arash Behravesh, Arlington, VA (US)

Correspondence Address: ARASH BEHRAVESH, 3364 SOUTH SECOND ST., ARLINGTON, VA, 22204, US

(21) Appl. No.: 11/449,705

(22) Filed: Jun. 9, 2006

(51) Int. Cl. A23N 5/00

(52) U.S. Cl. 30/120.1

(57) ABSTRACT

An egg cracking device and method that includes (i) a rod having a proximal end and a distal end and (ii) a hollow body having a predetermined mass and slidably arranged around the rod. Alternatively, the egg cracking device includes (i) a hollow body having an edge and designed to be disposed over and about an end portion of an egg, (ii) a rod connected to the hollow body and arranged such that the center of the rod and the center of the hollow body are aligned by their longitudinal axes, and (iii) an object slidably arranged around the rod.

### FIELD OF THE INVENTION

The present teachings relate to an egg cracker apparatus and method. In particular, the present teachings relate to an apparatus that allows a user to remove a portion of an egg shell as one piece. Additionally, the present teachings relate to an apparatus that allows a user to remove the content of the egg without substantial damage to the egg shell.

### BACKGROUND OF THE INVENTION

Typically, emptying the content of an egg requires breaking a portion of the exposed shell. Generally, this process is accomplished by bringing the portion of the exposed shell in contact with a force that causes the shell to break into several small pieces. The small broken pieces of the shell are then removed by hand and disposed. However, removing each of the individual broken pieces by hand is time consuming and difficult to perform. Moreover, the broken pieces of the egg shell cannot be put back together in order to use the emptied egg shell for decorative purposes.

Accordingly, there exists a need for an egg shell cracker or opener that: (i) removes a portion of the egg shell in a single piece, (ii) is simple and easy to use, (iii) is easy to manufacture, and (iv) is economical to purchase.

### SUMMARY OF THE INVENTION

According to one embodiment of the present teachings, the egg cracker includes (i) a rod having a proximal end and a distal end and (ii) a hollow body having a predetermined mass and slidably arranged around the rod.

The egg cracker of the present teachings can also include a rod holder attached to one end (e.g., the distal end) of the rod and is capable of holding the rod on a pole of an egg.

According to a second embodiment of the present teachings, the egg cracker includes: (i) a hollow body having an edge and designed to be disposed over and about an end portion of an egg, (ii) a rod connected to the hollow body and arranged such that the center of the rod and the center of the hollow body are aligned by their longitudinal axes, and (iii) an object slidably arranged around the rod.

According to the present teachings, the egg cracker can also include a stopper at a second end (e.g., the proximal end) of the rod.

According to the present teachings, the object or the slidable hollow body has a mass sufficient to generate a force capable of cracking, breaking, penetrating, and/or detaching a portion of an eggshell from the egg.

The present teachings also describe a method for removing a portion of an eggshell in one single piece. The method includes: (i) placing a rod holder, attached to the distal end of a rod, on a pole of an egg, (ii) sliding a slidable hollow body arranged around the rod to the proximal end of the rod, and (iii) releasing the slidable hollow body to contact a circumference of an eggshell with a sufficient force to crack, break, penetrate, and/or detach a portion of the eggshell from the remainder of the eggshell.

The present teachings also describe a method for removing a portion of an eggshell in one single piece. The method includes placing a hollow body, attached to the distal end of a rod, over an egg. Preferably, the edge of the hollow body engages the eggshell along a circular line of contact lying intermediate to the equator and a pole. The method further includes sliding a slidable object arranged around the rod to the proximal end of the rod, and releasing the object to slide down the rod and exert a sufficient force on the hollow body engaged with the eggshell to crack, break, penetrate, and/or detach the portion of the eggshell along the circular line of the contact from the rest of the eggshell.

Additional features and advantages of various embodiments will be set forth, in part, in the description that follows, and will, in part, be apparent from the description, or may be learned by the practice of various embodiments. The objectives and other advantages of various embodiments will be realized and attained by means of the elements and combinations particularly pointed out in the description herein.

### BRIEF DESCRIPTION OF THE DRAWINGS

FIG. 1 is a perspective view of the egg cracker according to various embodiments;

FIG. 2 is a perspective view of the egg cracker of FIG. 1 over an egg prior to cracking, breaking, penetrating, or detaching a portion of the eggshell according to various embodiments;

FIG. 3 is a perspective view of the egg cracker over an egg after cracking, breaking, penetrating, or detaching a portion of the eggshell according to various embodiments;

FIG. 4A shows a close-up view of region A of FIG. 1 and illustrates a straight and flat edge capable of engaging an eggshell according to various embodiments;

FIG. 4B shows a close-up view of region A of FIG. 1 and illustrates a straight and sharp edge capable of engaging an eggshell according to various embodiments;

FIG. 4C shows a close-up view of region A of FIG. 1 and illustrates a straight and serrated edge capable of engaging an eggshell according to various embodiments;

FIG. 5A shows a close-up view of region A of FIG. 1 and illustrates a beveled and serrated edge capable of engaging an eggshell according to various embodiments;

FIG. 5B shows a close-up view of region A of FIG. 1 and illustrates a beveled and sharp edge capable of engaging an eggshell according to various embodiments;

FIG. 5C shows a close-up view of region A of FIG. 1 and illustrates a beveled and hook-shaped edge capable of engaging an eggshell according to various embodiments;

FIG. 6 is a perspective view of the egg cracker including a semi-hemisphere hollow body according to various embodiments;

FIG. 7 is a perspective view of the egg cracker of FIG. 6 placed over an egg prior to cracking, breaking, penetrating, and/or detaching a portion of the eggshell according to various embodiments;

FIG. 8 is a perspective view of the egg cracker placed over an egg after cracking, breaking, penetrating, and/or detaching a portion of the eggshell according to various embodiments;

FIG. 9 is an alternative perspective view of the egg cracker including a cone hollow body according to various embodiments;

FIG. 10A is an alternative perspective view of the egg cracker including a cylindrical hollow body centrally attached to a rod by at least one prong according to various embodiments;

FIG. 10B is an alternative perspective view of the egg cracker including a cylindrical hollow body with a solid top surface that is centrally attached to a rod according to various embodiments;

FIG. 11 is an alternative perspective view of the egg cracker including a circular edge, a ring, and at least two bowed prongs connecting the ring to the circular edge according to various embodiments;

It is to be understood that both the foregoing general description and the following detailed description are exemplary and explanatory only, and are intended to provide an explanation of various embodiments of the present teachings.

### DETAILED DESCRIPTION OF THE PREFERRED EMBODIMENTS

The present teachings are directed to egg cracking tools and methods thereof that allow a user to crack, break, penetrate, remove, and/or detach a portion of an eggshell in one single piece from the remainder of the eggshell.

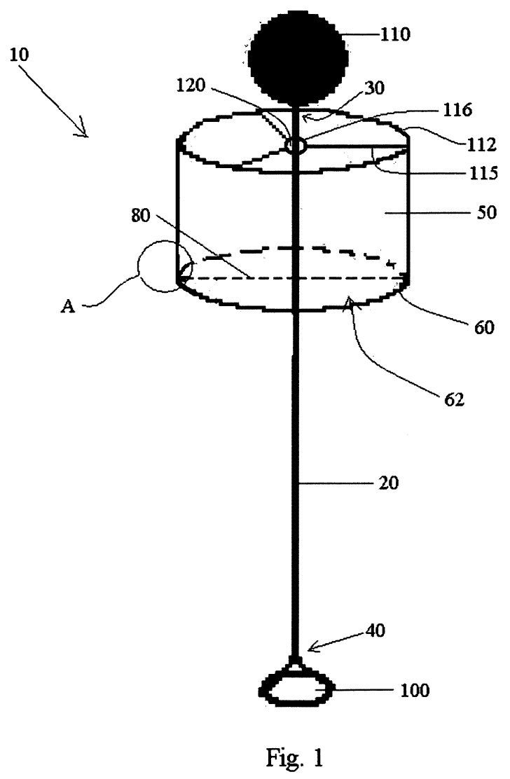

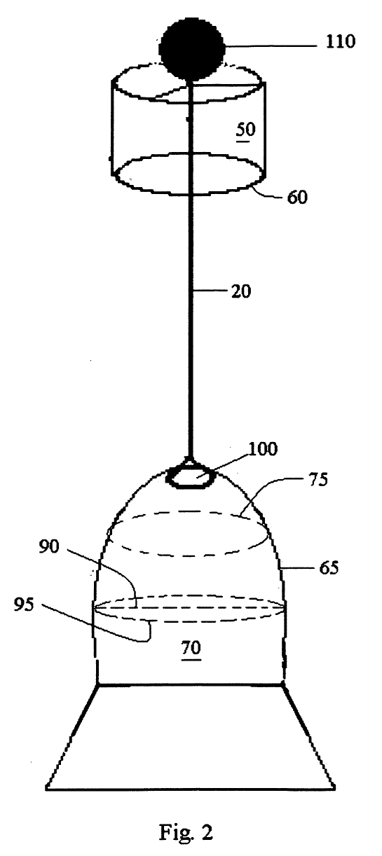

In one exemplary embodiment of the present teachings, as shown in FIGS. 1-3, an egg cracker 10 includes a rod 20 having a predetermined length, a proximal end 30 and a distal end 40. Additionally, the egg cracker 10 includes a hollow body 50 that is slidably arranged around the rod 20, such that hollow body 50 can move or slide in the longitudinal axis of the rod 20. The hollow body 50 includes an edge or rim 60 that defines a first opening 62, having a diameter 80. Preferably, the diameter 80 is less than the widest cross-section of an egg 70. For example, as shown in FIG. 2, the diameter 80 is less then the diameter 90 at an equator 95 of the egg 70. Furthermore, the edge 60 is capable of coming in contact with a portion of the eggshell 65 of the egg 70.

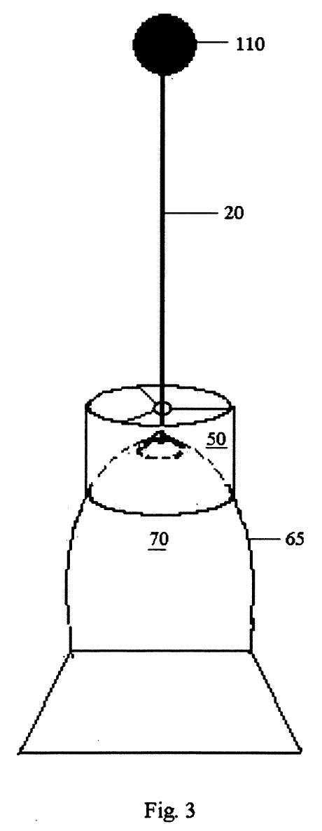

In one exemplary embodiment, as shown in FIG. 2, to remove a portion of the eggshell, the rod 20 having the hollow body 50 slidably arranged therein can be positioned at a pole of the egg 70. The slidable hollow body 50 can then be moved towards the proximal end 30 of the rod 20. The hollow body 50 is then released to slide, fall, or drop down the rod 20 towards the egg 70. As shown in FIG. 3, the falling hollow body 50 is stopped when the edge 60 of the hollow body 50 comes in contact with the egg 70 at the circular line of contact or a circumference 75. Preferably, the sliding hollow body 50 exerts a sufficient force for its edge 60 to crack, break, penetrate, and/or detach a portion of the eggshell 65 at the circumference 75. The force of the hollow body 50 impacting the eggshell 65 can be a force of less than about 40 N. For example, the force can be from about 0.001 N to about 30 N, preferably less than about 30 N and, most preferably less than 20 N.

To secure the rod 20 to a pole of the egg 70, a rod holder 100 can be placed or positioned at the distal end 40 of the rod 20. Preferably, the rod holder 100 is designed or is configured to prevent the rod 20 and the slidable hollow body 50 from falling off a pole of the egg 70. More preferably, the rod holder 100 is designed to also prevent the slidable hollow body 50 that is slidably arranged around the rod 20 from sliding off from the distal end of the rod 20 when the egg cracker 10 is not in use. In one exemplary embodiment, the rod holder 100 can include a suction device, (e.g., a suction cup), an adhesive material, a pin, and/or any other known materials or devices that are capable of stabilizing the rod 20 and the slidable hollow device 50 to a pole of the egg 70. When adhesive material is used to stabilize the rod 20 to a pole of the egg 70, the adhesive material can be in a form or re-usable adhesive material, such as the adhesive composition used in POST-IT; layers of adhesive material that can be removed or replaced after each use; or any other known adhesives materials. In an exemplary embodiment, when the rod holder 100 is not utilized, an optional stopper can be placed at the distal end 40 of the rod 20 to prevent the slidable hollow device 50 arranged around the rod 20 from sliding off from the distal end 40 of the rod 20.

Additionally, a stopper 110 can be positioned at the proximal end 30 of the rod 20 to prevent the slidable hollow body 50 from sliding off from the proximal end 30 of the rod 20. In various exemplary embodiments of the present teachings, the stopper 110 can be made from a polymer, glass, and/or metal to name a few. Furthermore, the stopper 110 can have any ornamental shape. For example, the stopper 110 can be in the shape of: a hemisphere, such as a ball, earth, or moon; a cartoon character; a place; or an animal, such as a bird (e.g., a chicken), fox, dog, or cat.

The hollow body 50 of the present teachings can include any shape having the edge 60 that defines the first opening 62 and is capable of coming in contact with the eggshell 65 at the circular line of contact or the circumference 75 of the eggshell 65. For example, the hollow body 50 can resemble a hollow round plinth, cylinder, semi-hemisphere, cone, or two rings that are separated from each other by a predetermined distance, are positioned on the same longitudinal axis and are connected to one another by at least a prong.

When the hollow body 50 is in the shape of a cylinder, as shown in FIG. 1, the cylinder can have the first opening 62 defined by the edge 60 and a second opening 120 defined by a ring 116. In one exemplary embodiment, the ring 116 and the second opening 120 are in the same plane as the top edge 112 of the cylinder. Moreover, the opening 120 includes a diameter that is at least slightly larger than the diameter of the rod 20 and is arranged at the center of the plane defined by the edge 112 of the cylinder. Additionally, the opening 120 can face the first opening 62. In this exemplary embodiment, the rod 20 can be inserted through the first opening 62 and the second opening 120 of the cylinder, thereby allowing the cylinder to move in the longitudinal axis of the rod 20. In one example, as shown in FIG. 1, prongs 115 connect the top edge 112 of the cylinder to the ring 116. Alternatively, the prongs 115 and the ring 116 can be replaced by a washer having a circumference that is connected to the top edge 112 of the cylinder and a central opening having a diameter sufficient to enable the cylinder to slide along the longitudinal axis of the rod 20. Similarly, when the hollow device 50 includes a shape of a semi-hemisphere or a cone, the peak of the semi-hemisphere or the cone can include an opening 120 that has a diameter sufficient to enable the semi-hemisphere or cone to slide along the length of the rod 20.

In various exemplary embodiments of the present teachings, the hollow body 50 includes a first ring having the edge 60 and at least two prongs having a first end connected to the first ring and a second end positioned away from the first ring and located in the longitudinal axis of the first ring. Preferably, the prongs are configured not to come in contact with the eggshell 65, but allow the edge 60 to come in contact with the eggshell 65 so as to crack, break, penetrate, and/or detach a portion of the eggshell 65 at the circumference 75. In one example, the prongs are bowed or arched to prevent them from coming in contact with the eggshell 65, but allow the edge 60 to come in contact with the eggshell 65 at the circumference 75. In various exemplary embodiments of the present teachings, the second end of the prongs are configured and arranged to enable the first ring to slide and/or move in the longitudinal axis of the rod 20. For example, the second end of the prongs can be connected to a second ring similar to the ring 116, shown in FIG. 1, having a diameter that is at least slightly larger than the diameter of the rod 20; thereby enabling the first ring to slide or move in the longitudinal axis of the rod 20. Preferably, the second ring is centrally arranged with respect to the first ring, such that the distance between each of the first end of the prongs connected to the first ring having the edge 60 and the second end of the prongs connected to the second ring are substantially the same.

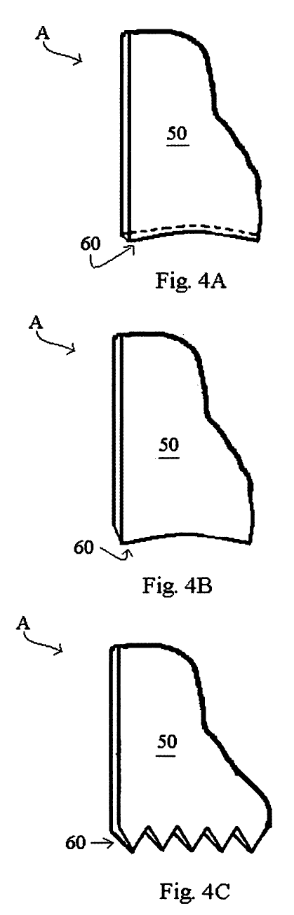

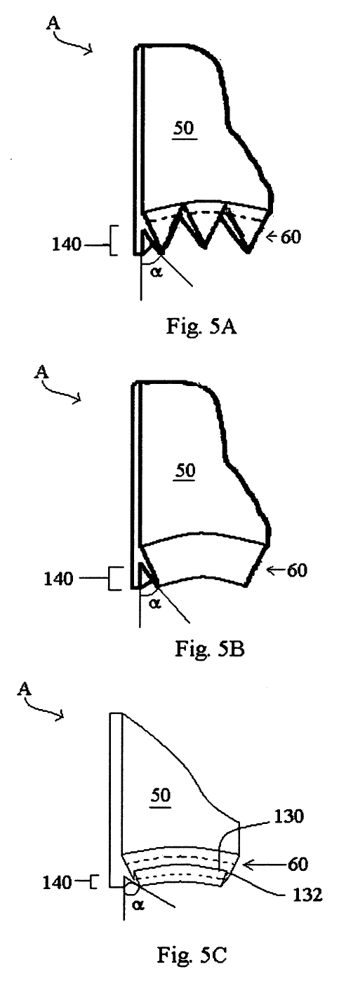

In various exemplary embodiments of the present teachings, the edge 60 of the present teachings can include any shape or design. Some exemplary shapes and designs of the edge 60 are shown in FIGS. 4A-5C. For example, the edge 60 of the present teachings can be straight, as shown in FIGS. 4A-4C, or can be beveled, as shown in FIGS. 5A-5C.

When the edge 60 includes a straight configuration, the tip of the edge 60 can be flat, as shown in FIG. 4A, can be sharp, as shown in FIG. 4B, or can be serrated, as shown in FIG. 4C. When the edge 60 includes a beveled configuration, the edge 60 can be serrated, as shown in FIG. 5A, can be sharp, as shown in FIG. 5B, or can include a lip 130 (e.g., can be hook-like), as shown in FIG. 5C. The angle of the beveled edge can be any angle capable of cracking, breaking, penetrating, and/or detaching a portion of the eggshell at the circumference 75. For example, as shown in FIGS. 5A-5C, the beveled angle α can be from about 30 degrees to about 60 degrees. Preferably, the angle is about 45 degrees.

As shown in FIG. 5C, the lip 130 of the edge 60 can act as a hook. In one exemplary embodiment, when the hollow body 50 is released from the proximal end 30 of the rod 20, the force of the hollow body 50, having the lip 130 at the edge 60, can penetrate the lip 130 into the eggshell 65 at the circumference 75. Once the lip 130 penetrates the eggshell 65, the edge of the eggshell 65 at the circumference 75 can be secured in a groove 132. To remove a portion of the eggshell 65 above the circumference 75, the hollow body 50 having secured the portion of the eggshell 65 above the circumference 75 by the groove 132 can be moved towards the proximal end 30 of the rod 20 by sliding the hollow body 50 with the secured portion of the eggshell 65 in the longitudinal axis of the rod 20.

Optionally, as shown in FIGS. 5A-5C, the hollow body 50 can include a safety shield 140 surrounding the edge 60. The safely shield 140 can be an extension of the exterior surface of the hollow body 50 or it can be a separate piece connected to the hollow body 50 arranged such that the safety shield 140 can prevent a user from coming in direct contact with the edge 60.

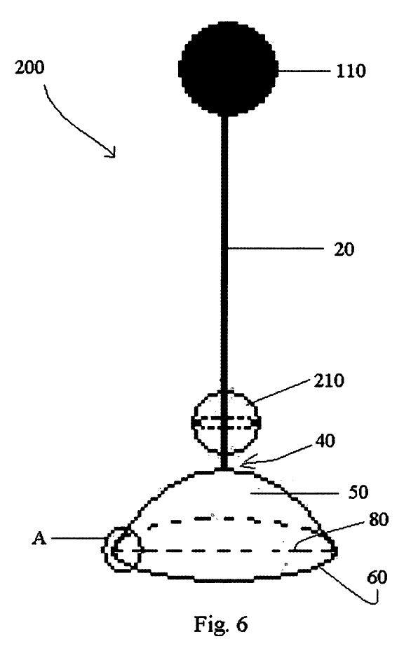

In another embodiment of the present teachings, as shown in FIGS. 6-8, egg cracker 200 includes the hollow body 50 having the edge 60 that is capable of being disposed over and about a pole of the egg 70 to engage the eggshell 65. Furthermore, the edge 60 defines the first opening 62 having the diameter 80. Preferably, the diameter 80 is less than the diameter 90 of the eggshell 65 at the equator 95 of the egg 70. However, unlike the previous embodiment relating to FIGS. 1-3, in this embodiment, the top portion of the hollow body 50 is fixed to the distal end 40 of the rod 20. Preferably, the distal end 40 and the top portion of the hollow body 50 are arranged such that a center of the rod 20 and a center of the hollow body 50 are aligned by their longitudinal axes. Accordingly, in this alternative exemplary embodiment, the hollow body 50 is not capable of moving along the longitudinal axis of the rod 20. Moreover, the egg cracker 200 of the present teachings includes an object 210 having a predetermined mass. The object 210 can be slidably arranged around the rod 20 and can be capable of providing a sufficient force to the hollow body 50 to crack, break, penetrate, or detach a portion of the eggshell 65 at the circumference 75. Preferably, the force of the object 210 is from about 0.001 N to about 40 N, more preferably, less than about 30 N and, most preferably, less than about 20 N.

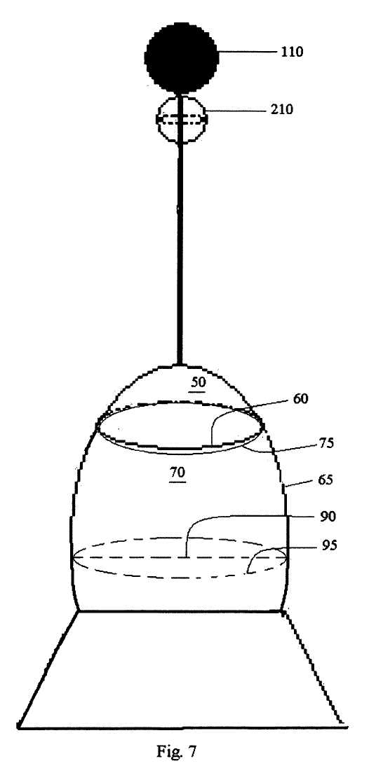

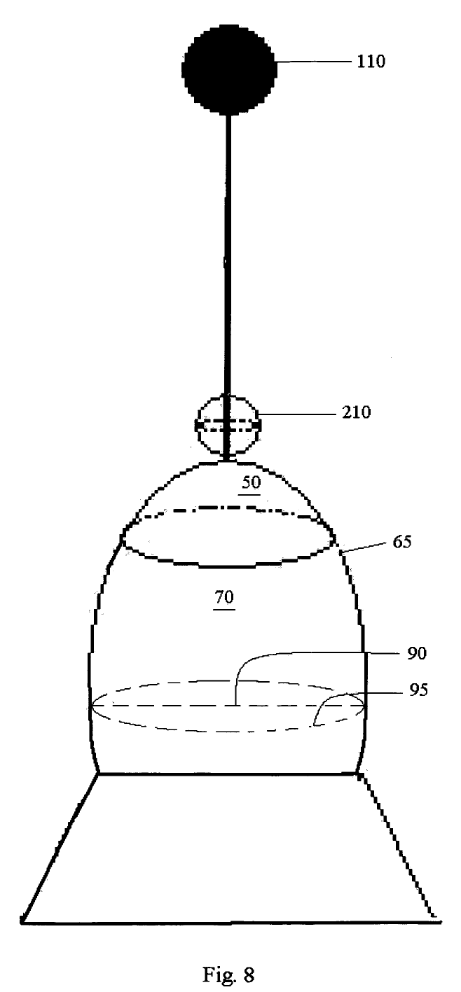

In one exemplary embodiment, as shown in FIG. 7, to remove a portion of the eggshell, the hollow body 50 can be placed over the egg 70, such that the edge 60 can engage the eggshell 65 along or proximate to a circular line of contact lying intermediate to the equator 90 and a pole of the egg 70. The slidable object 210 can then be moved towards the proximal end 30 of the rod 20. The slidable object 210 is then released to slide down the rod 20 towards hollow body 50. As shown in FIG. 8, when the object 210 strikes the top portion of the hollow body 50, the object 210 exerts a force on the hollow body 50 and the edge 60. Preferably, the force exerted by the object 210 is sufficient for the edge 60 to crack, break, penetrate, or detach the eggshell 65 along a circular line of contact lying intermediate to the equator 90 and a pole.

Optionally, a stopper 110 can be positioned at the proximal end 30 of the rod 20 to prevent the object 210 from sliding off from the proximal end 30 of the rod 20. As discussed above, the stopper 110 can be in any shape, form, or design. For example, the stopper 110 can be made of a polymer, glass, and/or metal. Furthermore, the stopper 110 can have any ornamental shape or figure. For example, the stopper 110 can be in the shape of a hemisphere, such as a ball, earth, or moon; a cartoon character; a shape or place; or an animal, such as a bird (e.g., a chicken), fox, dog, or cat.

The object 210 can also be made from any material. For example, the object 210 can be made from any type of metal, polymer, and/or glass. Furthermore, the object 210 can be in any shape or figure. For example, as illustrated in FIG. 6, the object 210 can be in the shape of a hemisphere or a ball. The object 210 can include other shapes, such as a semi-hemisphere, an egg, a disk, and an animal.

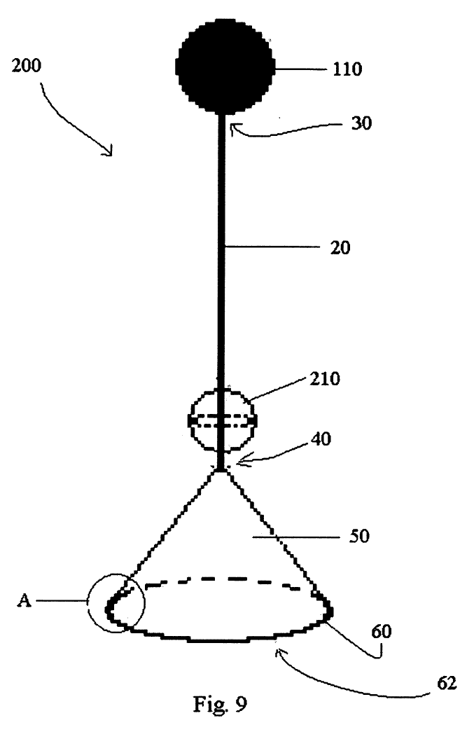

Similar to the exemplary embodiments with respect to FIGS. 1-3 of the present teachings, the hollow body 50 shown in FIGS. 6-8 of the present teachings can include any shape having the edge 60 that defines the first opening 62 and is capable of being in contact with a circumference portion of the eggshell 65. For example, the hollow body 50 can resemble a hollow round plinth, semi-hemisphere, cone, cylinder, or two rings that are separated from each other by a predetermined distance, are positioned on the same longitudinal axis, and are connected to one another by at least a prong. In one example, when the hollow body 50 is in a shape of a semi-hemisphere, as shown in FIG. 6, or a cone, as shown in FIG. 9, the peak of the semi-hemisphere or the cone is attached to the distal end 40 of the rod 20.

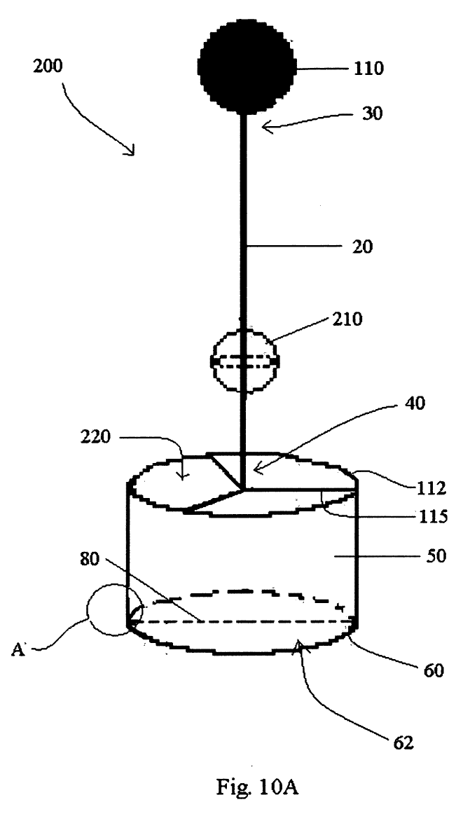

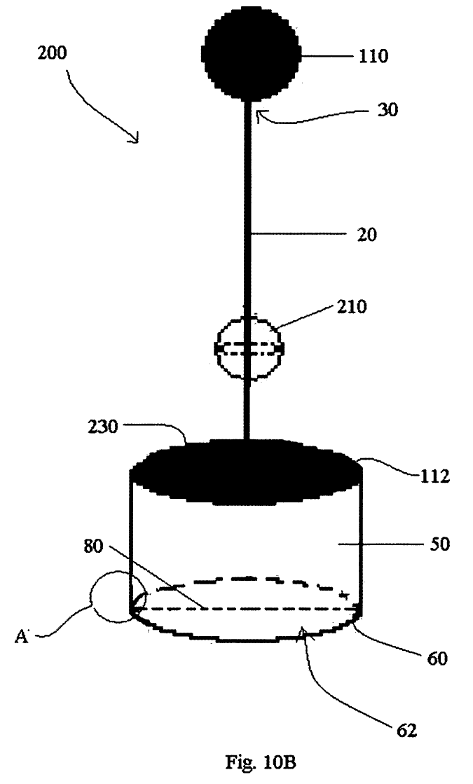

FIGS. 10A and 10B show an exemplary embodiment of the hollow body 50 having a shape of a cylinder. The cylinder, as shown in FIG. 10A, can include the opening 62 defined by the edge 60 and a second opening 220 facing the first opening 62 and defined by the top edge 112 of the cylinder. As shown in FIG. 10A, prongs 115 can connect the top edge 112 of the cylinder to the proximal end 40 of the rod 20. Alternatively, as shown in FIG. 10B, the cylinder can include the opening 62 defined by the edge 60 and a solid top surface 230. Preferably, in this alternative embodiment, the solid top surface 230 is centrally attached to the distal end 40 of the rod 20.

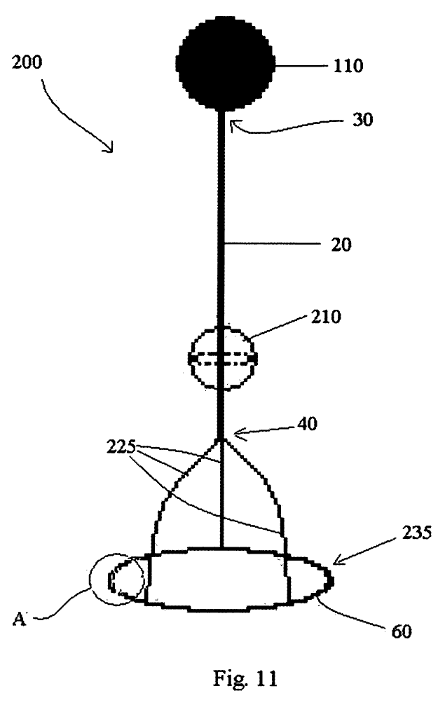

FIG. 11 shows yet another alternative embodiment of the hollow body 50. In this alternative embodiment, the hollow body 50 can include a first ring 235 having the edge 60 and at least two prongs 225 having first ends and second ends. Preferably, the first ends of the prongs 225 are attached to the edge 60 and the second ends of the prongs are attached to the distal end 40 of the rod 20. In one exemplary embodiment, the prongs 225 can include a shape and arrangement such that no portion of the prongs 225 can come in contact with the eggshell 65 when the hollow device 50 is placed over a portion of the egg 70. Preferably, the prongs 225 are bowed or include an arch to prevent the prongs 225 from coming into contact with the eggshell 65.

Similar to the embodiments with respect to FIGS. 1-3 of the present teachings, the edge 60 of the hollow body 50 of FIGS. 6-11 can include any shape or form, such as the shapes described above and shown in FIGS. 4A-5C.

From the foregoing description, those skilled in the art can appreciate that the present teachings can be implemented in a variety of forms. Therefore, while these teachings have been described in connection with particular embodiments and examples thereof, the true scope of the present teachings should not be so limited. Various changes and modifications may be made without departing from the scope of the teachings herein.

What is claimed is:

1. A tool for removing a portion of an eggshell comprising:
a rod having a proximal end and a distal end; and
a hollow body slidably arranged around the rod, wherein a portion of the hollow body is capable of contacting a portion of an eggshell of an egg and wherein the portion of the hollow body contacting the portion of the eggshell includes a first diameter that is less than a diameter of the eggshell at equator of the eggshell.

2. A tool according to claim 1, further comprising a rod holder attached to the distal end of the rod and is capable of securing the rod to a pole of an egg.

3. The tool according to claim 2, wherein the rod holder comprises a suction cup, an adhesive material, a sharp end, or a combination thereof.

4. A tool according to claim 1, further comprising a stopper arranged at the proximal end of the rod to prevent the slidable hollow body from sliding off the rod.

5. A tool according to claim 1, wherein the hollow body resembles a hollow round plinth having a first open end at one end and a second open end at an opposing end, and wherein the first open end is capable of engaging the eggshell, and the second open end comprises at least a prong that is capable of centrally and slidably positioning the hollow round plinth around the rod.

6. A tool according to claim 1, wherein the hollow body resembles a cone, a semi-hemisphere, a cylinder, or two rings being on a same longitudinal axis and being connected to one another by at least two prongs.

7. A tool according to claim 1, wherein the portion of the hollow body capable of contacting the portion of the eggshell is beveled at a predetermined angle.

8. A tool according to claim 7, wherein the beveled edge has an angle of from about 30 degrees to about 60 degrees.

9. A tool according to claim 7, further comprising a safety shield arranged around the beveled edge.

10. A tool according to claim 1, wherein the hollow body comprises a mass sufficient to generate a force capable of cracking, breaking, penetrating, detaching, or a combination thereof the egg at a predetermined location.

11. A tool according to claim 1, wherein the portion of the hollow body capable of contacting the portion of the eggshell is serrated or is in a shape of a hook.

12. A method for removing a portion of an eggshell in one single piece by implementing the tool of claim 1 comprising:
positioning the rod at a pole of the egg,
sliding the hollow body to the proximal end of the rod, and
releasing the hollow body to contact a portion of the eggshell with a sufficient force to crack, break, penetrate, detach, or a combination thereof the portion of the eggshell from the rest of the eggshell.

13. The method of claim 12 further comprises securing the rod to the peak of the egg by a rod holder.

14. A tool for removing a portion of an eggshell comprising:
a hollow body capable of being disposed over and about a pole of an eggshell and including a top portion and a bottom portion, wherein the bottom portion includes an edge that is capable of engaging an eggshell of an egg and has a diameter less than a diameter of the eggshell at equator;
a rod having a distal end and a proximal end, wherein the distal end of the rod is connected to the hollow body and arranged such that a center of the rod and a center of the hollow body are aligned by their longitudinal axes; and
an object slidably arranged around the rod.

15. A tool according to claim 14, further comprising a stopper arranged at the proximal end of the rod.

16. A tool according to claim 14, wherein the hollow body resembles a hollow round plinth having a first open end at one end and a second open end at an opposing end, and wherein the first open end is capable of engaging the eggshell, and the second open end is connected to the distal end of the rod by at least one prong.

17. A tool according to claim 14, wherein the hollow body is in a shape of a cone, semi-hemisphere, cylinder, or two rings connected to one another by at least two prongs.

18. A tool according to claim 14, wherein the edge is beveled at a predetermined angle.

19. A tool according to claim 18, wherein the beveled edge has an angle of from about 30 degrees to about 60 degrees.

20. A tool according to claim 18, further comprising a safety shield arranged around the beveled edge.

21. A tool according to claim 14, wherein the object includes a mass sufficient to exert a force on the edge of the hollow body capable of cracking, breaking, penetrating, detaching or a combination thereof the egg at a predetermined location.

22. A tool according to claim 14, wherein the edge is serrated or is in a shape of a hook.

23. A method for removing a portion of an eggshell in one single piece by implementing the tool of claim 14 comprising:
positioning the hollow body over the egg, such that the edge engages the eggshell along a circular line of contact lying intermediate an equator and a pole of an egg;
sliding the slidable object to the proximal end of the rod; and
releasing the slidable object to contact the hollow body with sufficient force to enable the edge to crack, break, penetrate, or detach the eggshell along the circular line of the contact.
